(19) United States
(12) Patent Application Publication
(10) Pub. No.: US 2026/0219631 A1
(43) Pub. Date: Jul. 30, 2026

(54) IMAGE FORMING APPARATUS WITH SIMPLE CONFIGURATION CAPABLE OF OPENING AND CLOSING SHUTTER OF DEVELOPING AGENT CONTAINER IN CONJUNCTION WITH OPENING AND CLOSING OPERATION OF COVER PORTION

(71) Applicant: KYOCERA Document Solutions Inc., Osaka (JP)

(72) Inventors: Takashi Morita, Osaka (JP); Koju Yamamoto, Osaka (JP)

(21) Appl. No.: 19/444,706

(22) Filed: Jan. 9, 2026

(30) Foreign Application Priority Data
Jan. 28, 2025 (JP) 2025-011972

(51) Int. Cl. G03G 21/16; G03G 15/08

(52) U.S. Cl. CPC G03G 21/1647; G03G 15/0886; G03G 21/1628; G03G 21/1633; G03G 2215/0692; G03G 2221/163; G03G 2221/1654; G03G 2221/1657; G03G 2221/1687; G03G 2221/169

(57) ABSTRACT

An image forming apparatus includes an apparatus main body, a cover portion, a shutter output portion, and a main linking mechanism. The apparatus main body has an attachment portion therein to which a developing agent container having a shutter input portion that receives external force to open and close a shutter that blocks a developing agent outlet is attached, and a main opening formed to communicate with the attachment portion. The cover portion is capable of opening and closing the main opening. The shutter output portion engages with the shutter input portion and displaces between an open position causing the shutter to open and a closed position causing the shutter to close. The main linking mechanism links the shutter output portion with the opening and closing operation of the cover portion.

### INCORPORATION BY REFERENCE

This application is based upon and claims the benefit of priority from the corresponding Japanese Patent Application No. 2025-011972 filed on January 28, 2025, the entire contents of which are incorporated herein by reference.

### BACKGROUND

The present disclosure relates to an image forming apparatus equipped with a developing agent container.

An electrophotographic image forming apparatus includes a photoconductor on whose surface an electrostatic latent image is formed, and a developing device that develops the electrostatic latent image using a developing agent. The developing agent is supplied to the developing device from a developing agent container.

The developing agent container is a consumable item that stores the developing agent and is attached to an attachment portion within the apparatus main body. An opening communicating with the attachment portion is formed in the apparatus main body, and the developing agent container is replaced when a cover portion that opens and closes the opening in an open state.

The developing agent container includes an openable/closable shutter that closes a developing agent outlet to prevent the developing agent from leaking when the developing agent container is replaced.

In addition, an image forming apparatus is known that includes a linking mechanism that closes a shutter in conjunction with an opening operation of a cover portion and opens the shutter in conjunction with a closing operation of the cover portion. More specifically, the linking mechanism includes a first pinion gear, a first rack gear, a second rack gear, a second pinion gear, and a switching mechanism. The first pinion gear is linked with rotation of a rotation shaft of the rotatably supported cover portion. The first rack gear engages with the first pinion gear and is displaced in a linear direction in conjunction with rotation of the first pinion gear. The second rack gear is arranged along a displacement direction of the first rack gear and displaces in conjunction with displacement of the first rack gear. The second pinion gear engages with the second rack gear and opens and closes the shutter by moving in conjunction with the second rack gear. The switching mechanism switches between enabling and disabling linking of the second rack gear with the closing operation of the cover portion.

### SUMMARY

An image forming apparatus according to one aspect of the present disclosure includes an apparatus main body, a cover portion, one or more shutter output portions, and a main linking mechanism. The apparatus main body has an attachment portion therein to which one or more developing agent containers are attached, the developing agent containers having a storage portion configured to store a powder developing agent and a shutter input portion configured to receive an external force for opening and closing a shutter that closes a developing agent outlet, the apparatus main body having a main opening communicating with the attachment portion. The cover portion is supported by the apparatus main body and is capable of opening and closing the main opening. The shutter output portion is provided in the apparatus main body corresponding to the developing agent container, engages with the shutter input portion, and is supported so as to be displaceable between an open position in which the shutter is opened via the shutter input portion and a closed position in which the shutter is closed via the shutter input portion. The main linking mechanism is provided within the apparatus main body and, by linking the shutter output portion with the opening and closing operation of the cover portion, causes the shutter output portion to displace to the open position when the cover portion closes and causes the shutter output portion to displace to the closed position when the cover portion opens. The main linking mechanism includes a pivoting portion, a rack gear, one or more pinion gears, and a switching mechanism. The pivoting portion pivots in conjunction with rotation of a rotation shaft of the rotatably supported cover portion. The rack gear displaces in a linear direction in conjunction with the pivoting of the pivoting portion. The pinion gear engages with the rack gear and causes the shutter output portion to displace in response to displacement of the rack gear. The switching mechanism releases the linking of the shutter output portion with the closing operation of the cover portion in response to a predetermined release operation, and enables the linking in response to a predetermined enable operation.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a perspective view of a cover portion in a closed state and an attachment portion in an image forming apparatus according to an embodiment.

FIG. 3 is a perspective view of a cover portion in an open state and an attachment portion in an image forming apparatus according to an embodiment.

FIG. 4 is a perspective view of a developing agent container.

FIG. 5 is a side view of a main linking mechanism when a cover portion is in a closed state in an image forming apparatus according to an embodiment.

FIG. 6 is a cross-sectional view of a main linking mechanism when a cover portion is in a closed state in an image forming apparatus according to an embodiment.

FIG. 7 is a cross-sectional view of a main part of a main linking mechanism when a cover portion is in a closed state in an image forming apparatus according to an embodiment.

FIG. 8 is a cross-sectional view of a main part of a main linking mechanism when a cover portion is in a transition state from a closed state to an open state in an image forming apparatus according to an embodiment.

FIG. 9 is a cross-sectional view of a main part of a main linking mechanism when a cover portion is in a transition state from a closed state to an open state in an image forming apparatus according to an embodiment.

FIG. 10 is a cross-sectional view of a main part of a main linking mechanism when a cover portion is in an open state in an image forming apparatus according to an embodiment.

FIG. 11 is a cross-sectional view of a main part of a main linking mechanism when a cover portion is in a transition state from an open state to a closed state in an image forming apparatus according to an embodiment.

FIG. 12 is a perspective view of a temporary fastening member in an image forming apparatus according to an embodiment.

FIG. 13 is a side view of a main part of a main linking mechanism when a cover portion is in an open state and a temporary fastening member is attached in an image forming apparatus according to an embodiment.

FIG. 14 is a cross-sectional view of a main part of a main linking mechanism when a cover portion is in an open state and a temporary fastening member is attached in an image forming apparatus according to an embodiment.

FIG. 15 is a cross-sectional view of a main part of a main linking mechanism when a cover portion is in a closed state and a temporary fastening member is attached in an image forming apparatus according to an embodiment.

### DETAILED DESCRIPTION

Hereinafter, an embodiment according to the present disclosure will be described with reference to the drawings. Note that the following embodiments are examples of a specific embodiment according the present disclosure, and do not limit the technical scope of the present disclosure.

### Configuration of Image Forming Apparatus 10

An image forming apparatus 10 according to an embodiment includes a printing device 4 that executes a printing process by electrophotography. The printing process is a process in which an image is formed on a sheet 9. The sheet 9 is an image forming medium such as paper or a sheet-like resin member.

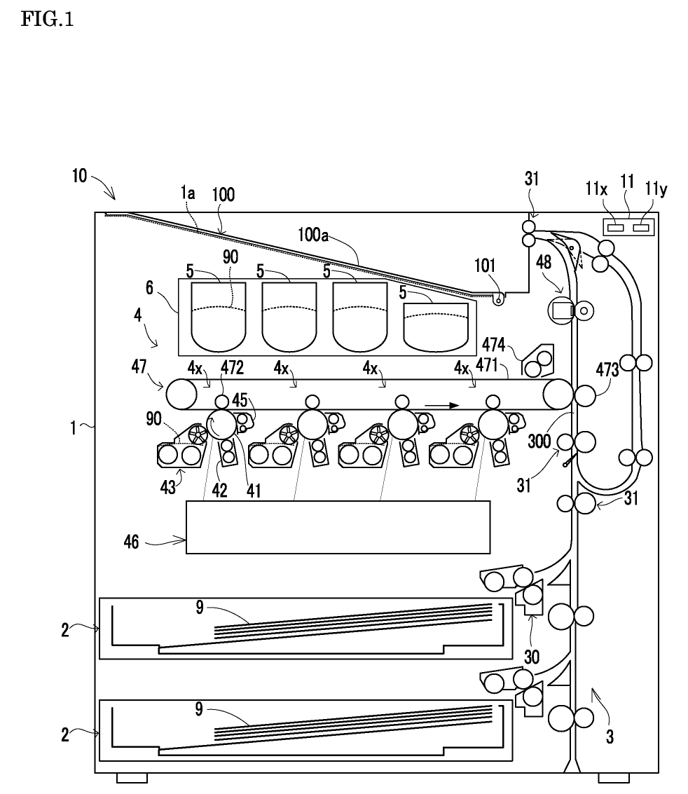

As shown in FIG. 1, the image forming apparatus 10 includes a sheet storing portion 2, and a sheet conveying device 3 and a printing device 4 provided in an apparatus main body 1. The apparatus main body 1 is a main housing that houses the printing device 4.

The sheet conveying device 3 includes a sheet feeding device 30 driven by a motor (not shown) and a plurality of conveying roller pairs 31. The sheet feeding device 30 feeds a sheet 9 stored in the sheet storing portion 2 to a conveying path 300 in the apparatus main body 1.

The plurality of conveying roller pairs 31 convey the sheet 9 along the conveying path 300, and then discharge the sheet 9 from the outlet of the conveying path 300 onto a discharge tray 100a.

The printing device 4 forms an image on the sheet 9 conveyed along the conveying path 300. The printing device 4 includes an image forming device 4x, an exposure device 46, a transfer device 47, and a fixing device 48. The image forming device 4x includes a drum-shaped photoconductor 41, a charging device 42, a developing device 43, a drum cleaning device 45, and the like.

The image forming apparatus 10 shown in FIG. 1 is a tandem color image forming apparatus. Therefore, the printing device 4 has four image forming devices 4x corresponding to four colors of toner 90: yellow, cyan, magenta, and black.

Furthermore, the transfer device 47 includes an intermediate transfer belt 471, four first transfer portions 472 corresponding to the four image forming devices 4x, a second transfer portion 473, and a belt cleaning portion 474.

In the image forming device 4x, the photoconductor 41 rotates, and the charging device 42 charges a surface of the photoconductor 41. Furthermore, the exposure device 46 writes an electrostatic latent image onto the surface of the photoconductor 41.

Further, the developing device 43 supplies toner 90 to the surface of the photoconductor 41, thereby developing the electrostatic latent image into a toner image. Note that the toner 90 is an example of a powder developing agent according to the present disclosure.

The transfer device 47 transfers the toner image onto the sheet 9 in the conveying path 300. The first transfer portion 472 transfers the toner image on the surface of the photoconductor 41 onto a surface of the intermediate transfer belt 471. Thus, a color toner image is formed on the surface of the intermediate transfer belt 471.

The second transfer portion 473 transfers the toner image formed on the intermediate transfer belt 471 onto the sheet 9 in the conveying path 300.

Note that in a case in which the image forming apparatus 10 is a monochrome image forming apparatus, the second transfer portion 473 transfers the toner image on the photoconductor 41 onto the sheet 9 in the conveying path 300.

The drum cleaning device 45 removes waste toner remaining on the surface of the photoconductor 41. The belt cleaning portion 474 removes waste toner remaining on the intermediate transfer belt 471.

The fixing device 48 fixes the toner image transferred onto the sheet 9 to the sheet 9 by applying heat and pressure.

The image forming apparatus 10 further includes a control device 11 that controls the sheet conveying device 3 and the printing device 4 (see FIG. 1). The control device 11 includes a processor 11x that executes a computer program and a storage device 11y that stores the computer program. The processor 11x executes the computer program, and the control device 11 executes various types of data processing and control operations.

The toner 90 is supplied to the developing device 43 from the toner container 5 (an example of a developing agent container according to the present disclosure). The toner container 5 contains toner 90 and is a consumable item that is detachable from the apparatus main body 1.

The image forming apparatus 10 further includes an attachment portion 6 to which the toner container 5 is attached. The toner container 5 is removably attached to an attachment portion 6 provided in the apparatus main body 1. The apparatus main body 1 has a main opening 1a that leads to the attachment portion 6.

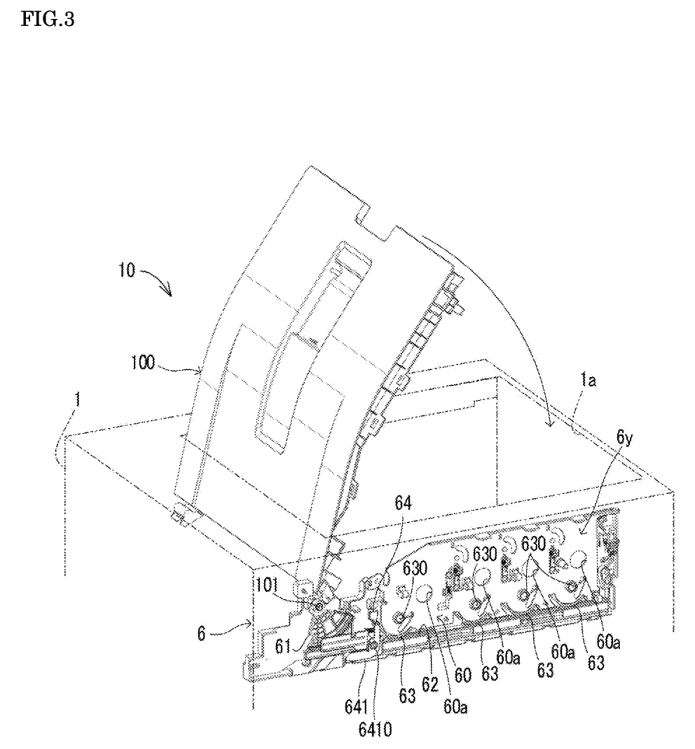

In the present embodiment, the main opening 1a is formed in an upper portion of the apparatus main body 1 (see FIG. 3). The image forming apparatus 10 further includes a cover portion 100 that covers the main opening 1a. The cover portion 100 can open and close the main opening 1a. In a state in which the cover portion 100 is open, the toner container 5 is replaced.

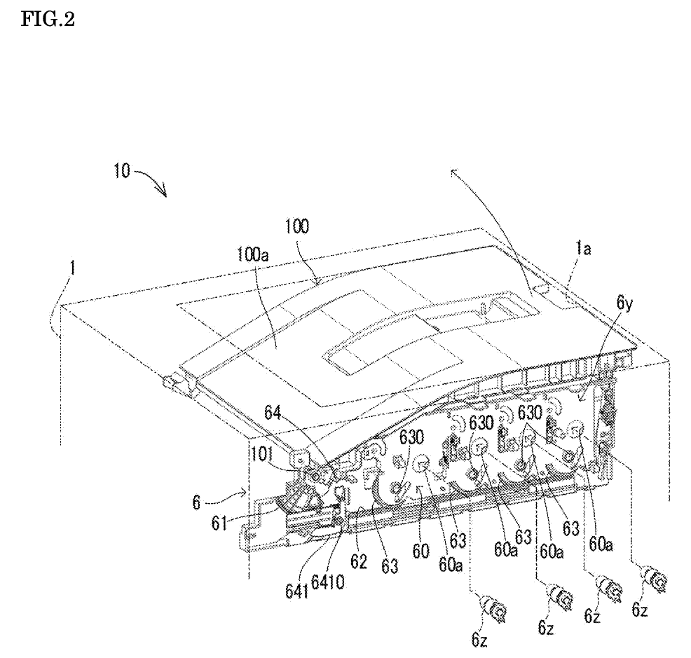

The cover portion 100 is supported by the apparatus main body 1 so as to be vertically rotatable (see FIGS. 2 and 3). A rotation shaft 101 of the cover portion 100 is rotatably supported by the apparatus main body 1. In the present embodiment, the cover portion 100 forms the discharge tray 100a.

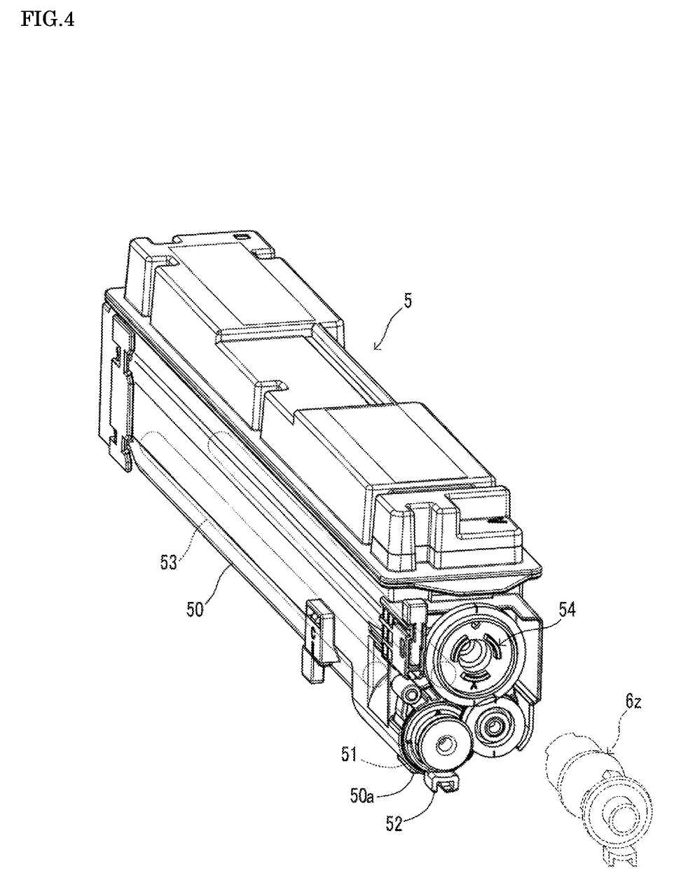

As shown in FIG. 4, the toner container 5 includes a storage portion 50, a shutter 51 and a shutter input portion 52. The storage portion 50 is a container that stores the toner 90. The shutter 51 is a member that closes the outlet 50a for the toner 90.

The outlet 50a is an opening that communicates with inside of the storage portion 50. The outlet 50a is formed at a lower portion of an end portion in a lengthwise direction of the toner container 5. The shutter 51 is attached to the storage portion 50 in a state in which the outlet 50a can be opened and closed.

The shutter input portion 52 is a portion that receives an external force that opens and closes the shutter 51. That is, by the shutter input portion 52 receiving an external force and displacing in a predetermined opening direction, the shutter 51 opens. On the other hand, by the shutter input portion 52 receiving an external force and displacing in a predetermined closing direction, the shutter 51 closes.

The shutter 51 is provided to prevent the toner 90 from leaking out from the outlet 50a when the toner container 5 is replaced.

Furthermore, the toner container 5 includes an internal rotating body 53 arranged in the storage portion 50 and a rotation input portion 54 that receives an external force that rotates the internal rotating body 53. The internal rotating body 53 is a conveying screw or the like that agitates and conveys the toner 90 in the storage portion 50. By the rotation input portion 54 being rotationally driven, the internal rotating body 53 rotates in conjunction with the rotation input portion 54.

As will be described later, the attachment portion 6 of the image forming apparatus 10 includes four shutter output portions 6x and a main linking mechanism 6y (see FIGS. 2, 3, 5, and 6. Furthermore, the attachment portion 6 also includes four rotation output portions 6z (see FIG. 2). The four shutter output portions 6x and the four rotation output portions 6z correspond to the four toner containers 5, respectively.

The shutter output portions 6x engage with the shutter input portions 52 of the toner containers 5. The rotation output portions 6z engage with the rotation input portions 54 of the toner containers 5.

The shutter output portions 6x are supported by a support plate 60 so as to be displaceable between a closed position and an open position. The main linking mechanism 6y displaces the shutter output portions 6x between the closed position and the open position in conjunction with the opening and closing operation of the cover portion 100.

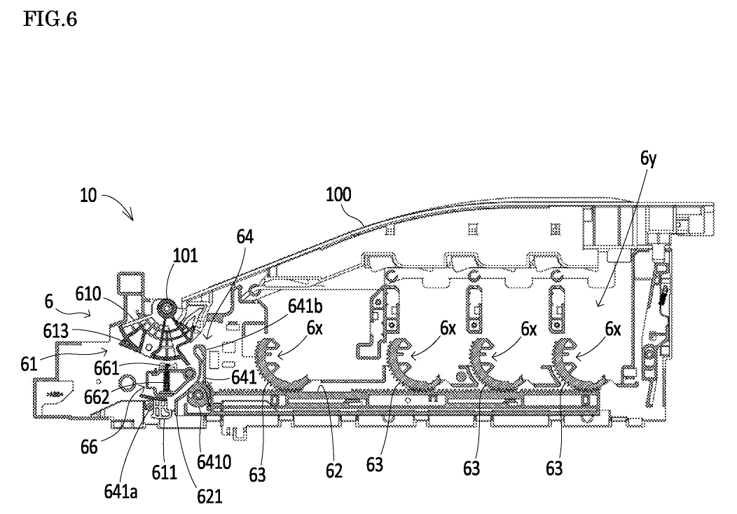

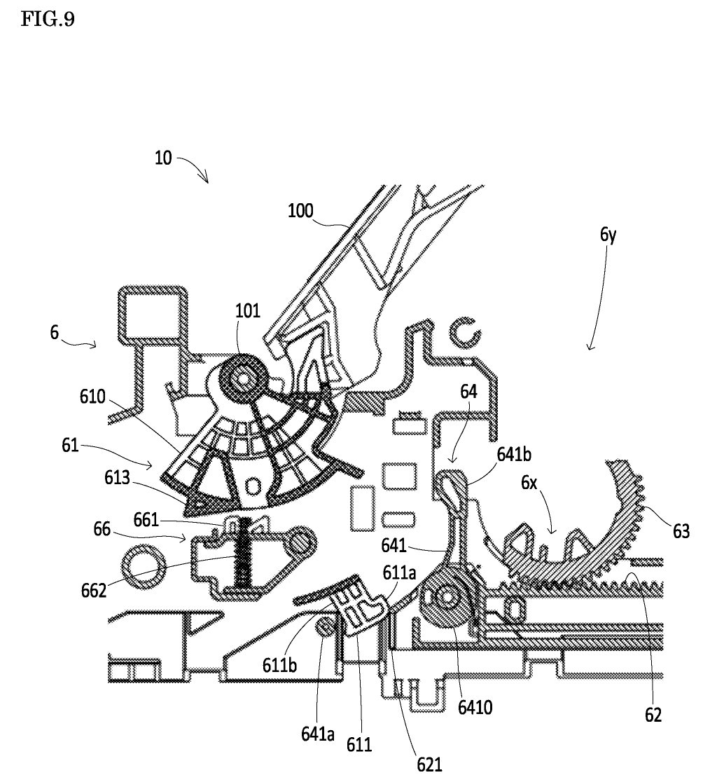

FIGS. 6 to 8 show a state in which the shutter output portions 6x are in the open position, and FIGS. 9 to 11 show a state in which the shutter output portions 6x are in the closed position. The shutter output portion 6x opens the shutter 51 via the shutter input portion 52 by being displaced to the open position. In addition, the shutter output portion 6x closes the shutter 51 via the shutter input portion 52 by being displaced to the closed position.

More specifically, the main linking mechanism 6y displaces the shutter output portion 6x to the closed position in conjunction with an opening operation of the cover portion 100. Thus, the shutter 51 of the toner container 5 closes.

Furthermore, the main linking mechanism 6y displaces the shutter output portion 6x to the open position in conjunction with a closing operation of the cover portion 100. Thus, the shutter 51 of the toner container 5 opens. The shutter output portion 6x and the main linking mechanism 6y will be described in detail later.

The action of the shutter output portion 6x and the main linking mechanism 6y prevents the toner 90 from scattering when the cover portion 100 is opened, without requiring any special operation.

In addition, the attachment portion 6 also includes four holders (not shown). The four holders, in a state of being inserted into four circular support holes 60a formed in the support plate 60, are rotatably supported by the support plate 60. The rotation output portions 6z are rotatably supported by the holders.

In addition, each of the rotation output portions 6z is rotationally driven by a driving device (not shown). Each of the holders is linked to the main linking mechanism 6y by a linking member (not shown), and displaces in a direction approaching the toner container 5 in conjunction with the closing operation of the cover portion 100. At this time, each of the rotation output portions 6z is displaced together with each of the holders in a direction approaching the toner container 5, and engages with the rotation input portion 54 of each of the toner containers 5.

That is, each of the rotation output portions 6z displaces to a position engaging with the rotation input portion 54 of each of the toner containers 5 in conjunction with the closing operation of the cover portion 100. Thus, a rotational force is transmitted from the rotation output portion 6z to the internal rotating body 53 via the rotation input portion 54. The drive device includes a motor and a gear mechanism (not shown).

Incidentally, an image forming apparatus including a main linking mechanism 6y composed of a first pinion gear, a first rack gear, a second rack gear, a second pinion gear, and a switching mechanism is known as related art. The first pinion gear is linked with rotation of a rotation shaft 101 of a cover portion 100. The first rack gear engages with the first pinion gear and is displaced in a linear direction in conjunction with rotation of the first pinion gear. The second rack gear is arranged along a displacement direction of the first rack gear and displaces in conjunction with displacement of the first rack gear. The second pinion gear engages with the second rack gear and opens and closes the shutter 51 by moving in conjunction with the second rack gear. The switching mechanism switches between enabling and disabling linking of the second rack gear with the closing operation of the cover portion 100.

Here, it is desirable that a configuration of the main linking mechanism 6y be as simple as possible.

In contrast, the image forming apparatus 10 of an embodiment according to the present disclosure has a simpler configuration than the image forming apparatus according to the related art described above, and is capable of opening and closing the shutter 51 of the toner container 5 in conjunction with the opening and closing operation of the cover portion 100, as described below.

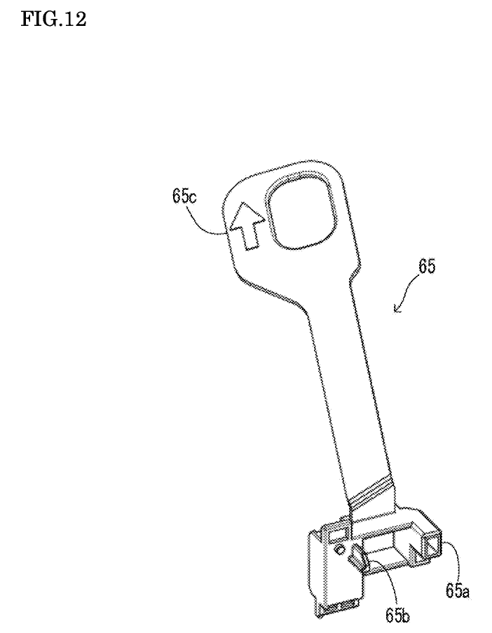

As shown in FIGS. 2, 3, 5, and 6, the attachment portion 6 includes the support plate 60, the four shutter output portions 6x corresponding to the four toner containers 5, and the main linking mechanism 6y. In addition, the attachment portion 6 also includes a temporary fastening member 65 (see FIG. 12). Moreover, the attachment portion 6 also includes a stopper 66 (an example of a locking portion according to the present disclosure) (see FIGS. 6 to 11).

The support plate 60 is arranged upright next to a space in the apparatus main body 1 where the four toner containers 5 are arranged, and supports devices of the main linking mechanism 6y.

As described above, the shutter output portions 6x are provided corresponding to the toner containers 5 and engage with the shutter input portions 52 of the toner containers 5. The shutter output portions 6x are supported so as to be displaceable between the open position and the closed position.

In the present embodiment, the main linking mechanism 6y includes a linking member 61, a rack gear 62, four pinion gears 63 corresponding to the four toner containers 5, and an auxiliary linking mechanism 64.

The auxiliary linking mechanism 64 includes an engaging member 641 and a first engaging spring 642 that form a unit together with the rack gear 62. The first engaging spring 642 applies an elastic force to the engaging member 641. The first engaging spring 642 is an example of an engaging elastic member according to the present disclosure.

The linking member 61 is integrally formed with the rotation shaft 101 of the cover portion 100 that is supported so as to be rotatable. Therefore, the linking member 61 moves in conjunction with the rotation shaft 101 and pivots along an arc centered on the rotation shaft 101.

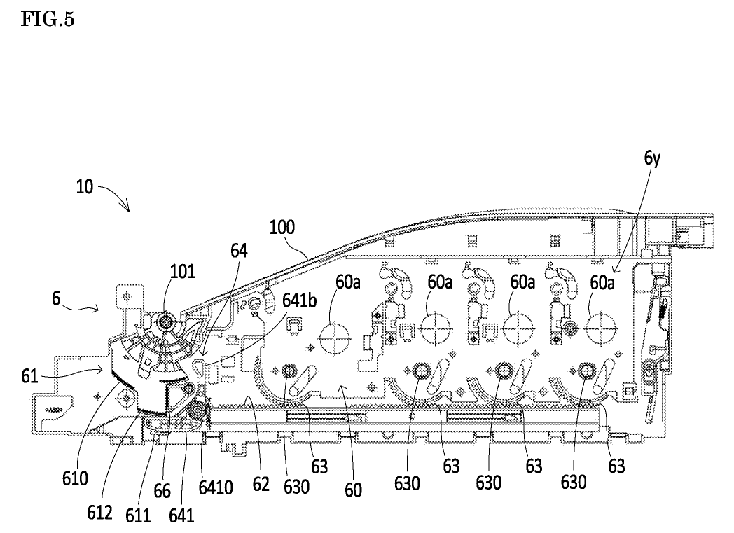

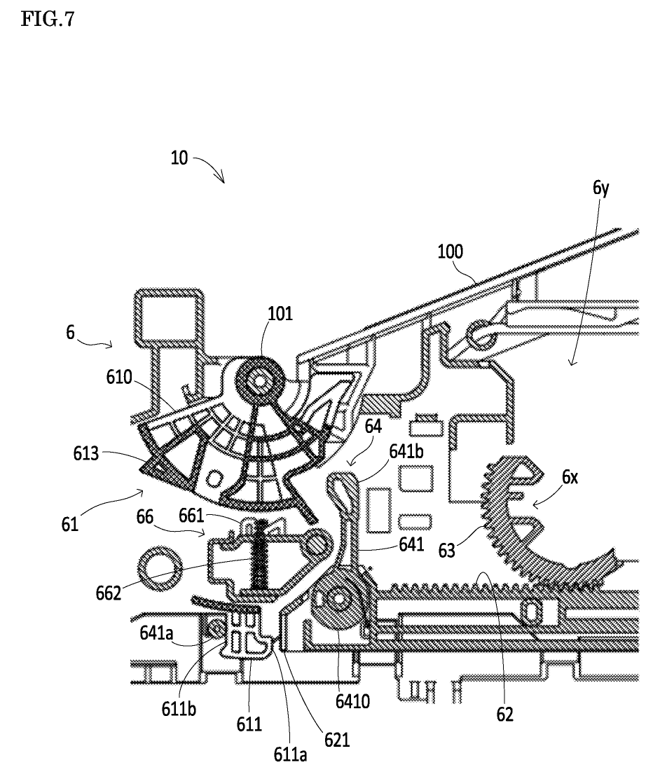

As shown in FIGS. 5 and 6, the linking member 61 has a fan-shaped portion 610, a pivoting portion 611, an arm portion 612, and an engaged portion 613. The fan-shaped portion 610 is a portion formed in a fan shape along an arc centered on the rotation shaft 101. The pivoting portion 611 is supported by an extending tip-end portion of the arm portion 612 that extends from the fan-shaped portion 610 in a radial direction perpendicular to the rotation shaft 101. The pivoting portion 611 includes a first contact portion 611a (see FIG. 7) facing one side in the pivoting direction of the linking member 61, and a second contact portion 611b (see FIG. 7) facing the other side in the pivoting direction. The engaged portion 613 is a protruding portion that protrudes from the fan-shaped portion 610 in the radial direction. In a case in which the cover portion 100 is in the open state, the engaged portion 613 is arranged at a locking position where the stopper 66 prevents the engaging portion 613 from pivoting.

The rack gear 62 is supported by the support plate 60 so as to be displaceable. The rack gear 62 displaces in a linear direction in conjunction with the pivoting of the pivoting portion 611 of the linking member 61.

The rack gear 62 is supported by the support plate 60 so as to be displaceable between a first position and a second position that are predetermined. FIGS. 6 to 8 show a state in which the rack gear 62 is at the first position, and FIGS. 9 to 11 show a state in which the rack gear 62 is at the second position.

The four pinion gears 63 have arc-shaped gear teeth, and are each formed integrally with a gear shaft 630 rotatably supported by the support plate 60 (see FIG. 2). Thus, each pinion gear 63 is able to pivot along an arc centered on the gear shaft 630.

The four pinion gears 63 engage with one rack gear 62. Therefore, the four pinion gears 63 pivot in conjunction with the rack gear 62.

The pinion gears 63 are integrated with the shutter output portions 6x (see FIG. 6). The four pinion gears 63 are linked to displacement of the rack gear 62, thereby causing the four shutter output portions 6x to displace between the open position and the closed position.

The engaging member 641 is supported so as to be able to pivot by a pivot shaft 6410 supported by the rack gear 62. The engaging member 641 has a protruding portion 641a that engages with the pivoting portion 611 of the linking member 61 that moves in conjunction with the closing operation of the cover portion 100.

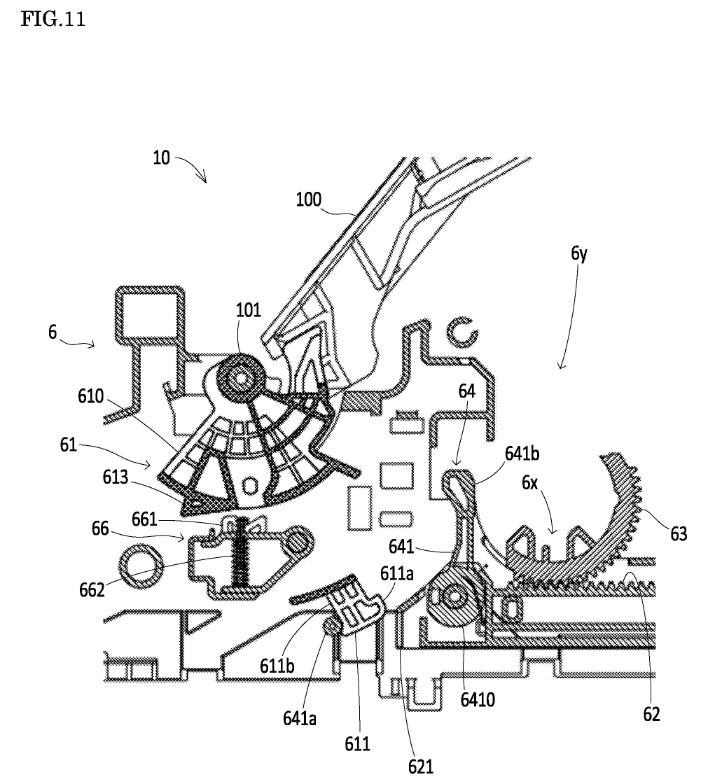

The engaging member 641 is supported so as to be pivotable between an engaging position and a release position. In a case in which the engaging member 641 is in the engaging position, when the pivoting portion 611 of the linking member 61 moves in conjunction with the closing operation of the cover portion 100, the protruding portion 641a of the engaging member 641 comes into contact with and engages with a second contact portion 611b of the pivoting portion 611 (see FIG. 11). When the engaging member 641 is in the release position, the protruding portion 641a is held in a position where the engaging member 641 does not engage with the pivoting portion 611.

That is, when the engaging member 641 is in the engaging position, the protruding portion 641a is located within the movement path of the pivoting portion 611 of the linking member 61 when the pivoting portion 611 is displaced by the closing operation of the cover portion 100. On the other hand, when the engaging member 641 is in the release position, the protruding portion 641a is positioned outside the movement path of the pivoting portion 611 of the linking member 61 when the pivoting portion 611 is displaced by the closing operation of the cover portion 100.

The first engaging spring 642 holds the engaging member 641 at the engaging position by an elastic force thereof. That is, the first engaging spring 642 elastically biases the engaging member 641 in a direction from the release position to the engaging position. The first engaging spring 642 is a torsion coil spring that is wound around the pivot shaft 6410.

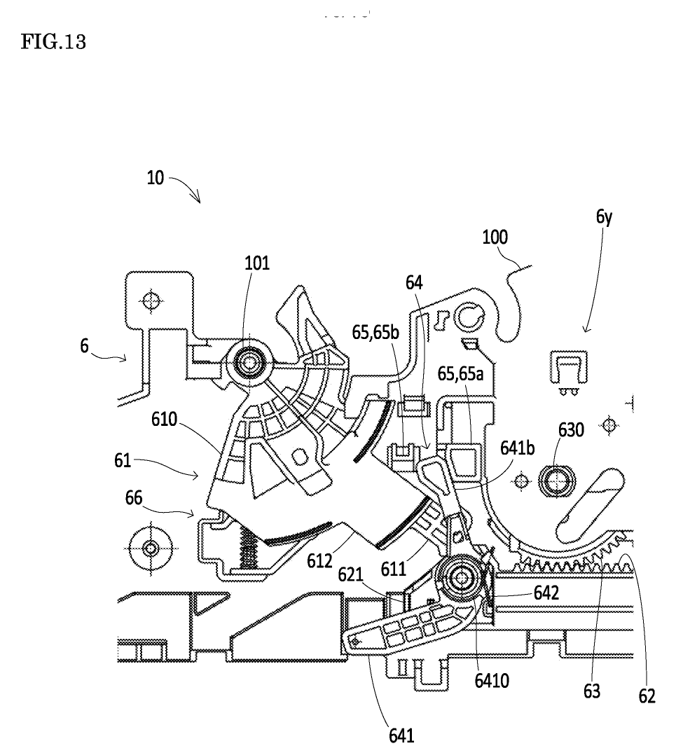

FIGS. 5 to 11 show a state in which the engaging member 641 is in the engaging position, and FIGS. 13 to 15 show a state in which the engaging member 641 is in the release position.

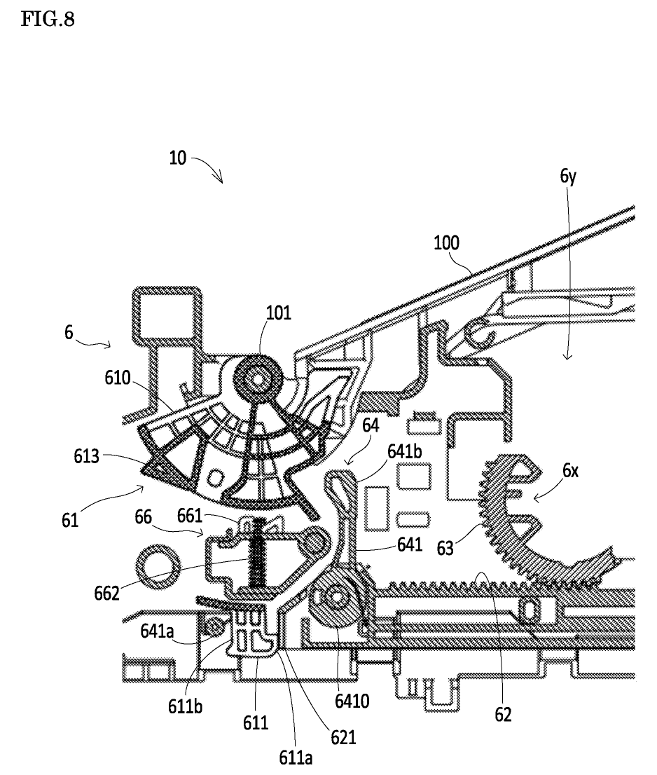

The pivoting portion 611 of the linking member 61, which is linked to the opening operation of the cover portion 100, causes the rack gear 62 to displace to the second position by the first contact portion 611a coming in contact with a pressed portion 621, which is one end of the rack gear 62 (see FIGS. 8 and 9). Furthermore, in conjunction with the displacement of the rack gear 62 to the second position, the shutter output portions 6x displace from the open position to the closed position (see FIG. 9). Thus, the shutters 51 of the four toner containers 5 close.

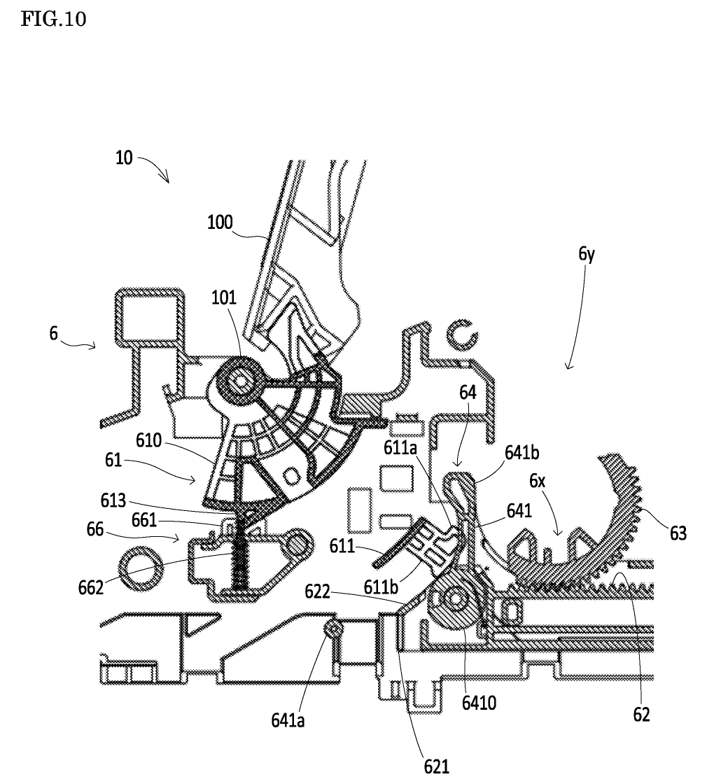

Here, the main linking mechanism 6y causes the rack gear 62 to displace to the second position during the opening operation of the cover portion 100 (see FIG. 9). That is, the main linking mechanism 6y causes the shutter output portions 6x to displace to the closed position during the opening operation of the cover portion 100. When the rack gear 62 is arranged at the second position, the pressed portion 621 of the rack gear 62 is positioned outside the movement path of the pivoting portion 611 of the linking member 61 when the pivoting portion 611 is displaced by the opening operation of the cover portion 100. Furthermore, the rack gear 62 is formed with a sliding portion 622 (see FIG. 10) that extends upward from an upper end portion of the pressed portion 621. The sliding portion 622 is an arc-shaped curved surface that follows a circle drawn around the rotation shaft 101 when the rack gear 62 is displaced to the second position. In addition, the pivoting portion 611 is formed in a shape such that the distance from the rotation shaft 101 to the end portion of the pivoting portion 611 is equal to or less than the radius of curvature of the sliding portion 622. Therefore, after the rack gear 62 is arranged at the second position, the rack gear 62 is not linked to the opening operation of the cover portion 100.

Thus, it is possible to close the shutters 51 of the four toner containers 5 before the cover portion 100 is fully opened (before transition from the closed state to the open state is completed). Therefore, compared to a configuration in which the shutters 51 of the toner containers 5 are not completely closed until the opening operation of the cover portion 100 is completed, it is possible to suppress leakage of toner 90 from the outlets 50a of the toner containers 5 when the toner containers 5 are removed from the attachment portion 6 before the cover portion 100 is fully opened.

In addition, in a case in which the engaging member 641 is in the engaging position, the pivoting portion 611 of the linking member 61, which is linked to the closing operation of the cover portion 100, causes the rack gear 62 to displace to the first position by engaging with the protruding portion 641a (see FIG. 11). Furthermore, in conjunction with the displacement of the rack gear 62 to the first position, the shutter output portions 6x are displaced from the closed position to the open position (see FIG. 7). Thus, the shutters 51 of the four toner containers 5 open.

The stopper 66 prevents the cover portion 100 from rotating from the open state.

As shown in FIG. 7, the stopper 66 has an engaging portion 661 and a second engaging spring 662. In a case in which the cover portion 100 is in the open state, the engaging portion 661 engages with the engaged portion 613 of the linking member 61 to prevent the engaged portion 613 from pivoting in conjunction with the closing operation of the cover portion 100 (see FIG. 10). The engaging portion 661 is formed in a recessed shape that can engage with the engaged portion 613 that protrudes from the fan-shaped portion 610 in the radial direction. The engaging portion 661 is provided so as to be movable between an engaging position where the engaging portion 661 can engage with the engaged portion 613 arranged at the locking position, and a retreat position where the engaging portion 661 has retreated from the engaging position. The second engaging spring 662 elastically biases the engaging portion 661 in a direction from the retreat position toward the engaging position.

When the cover portion 100 is opened, the engaged portion 613 of the linking member 61 pivots toward the locking position in conjunction with the opening operation of the cover portion 100, and comes into contact with the engaging portion 661 before reaching the locking position. In a case in which the engaging portion 661 comes into contact with the engaged portion 613 that is pivoting toward the locking position, the engaging portion 661 is pressed toward the retreat position by the engaged portion 613 and retreats to the retreat position. When the engaged portion 613 reaches the locking position, the engaging portion 661 receives the biasing force of the second engaging spring 662 and advances to the engaging position, and engages with the engaged portion 613 (see FIG. 10). The engagement between the engaging portion 661 and the engaged portion 613 prevents the engaged portion 613 from pivoting from the locking position. Thus, the cover portion 100 is prevented from rotating from the open state.

The temporary fastening member 65 is a member that can be attached to and detached from the support plate 60. The temporary fastening member 65 is attached to the support plate 60 only in specific cases, such as when the image forming apparatus 10 is transported, and is removed from the support plate 60 before the image forming apparatus 10 is used. For example, the temporary fastening member 65 is attached to the support plate 60 before the image forming apparatus 10 is shipped.

As shown in FIG. 12, the temporary fastening member 65 has a first protrusion 65a, a second protrusion 65b, and a handle portion 65c. The first protrusion 65a and the second protrusion 65b are portions that grip a part of the support plate 60.

The first protrusion 65a and the second protrusion 65b, by being pressed against predetermined positions on the support plate 60, grip specific portions of the support plate 60. Thus, the temporary fastening member 65 is attached to the support plate 60. In addition, the temporary fastening member 65 is removed from the support plate 60 by pulling the handle portion 65c.

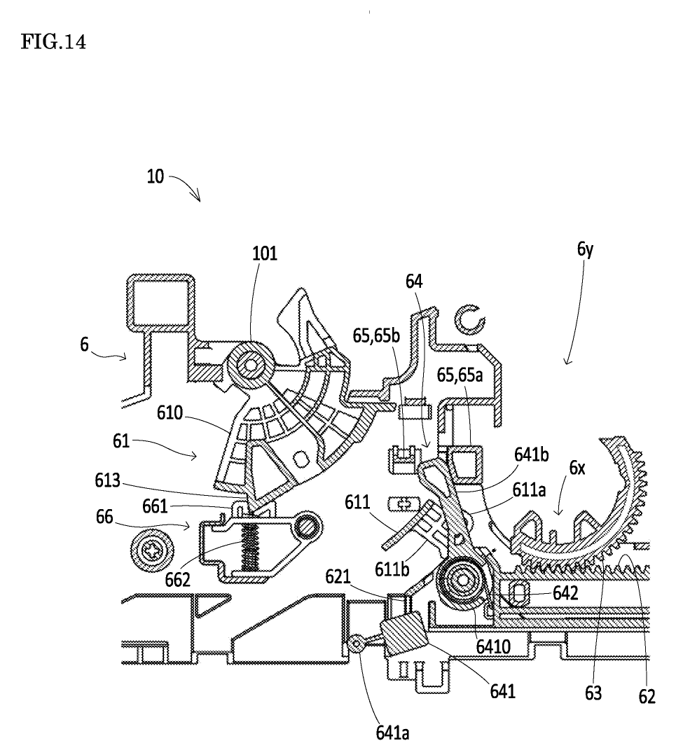

As shown in FIGS. 13 and 14, when the temporary fastening member 65 is attached to the support plate 60, the first protrusion 65a locks the engaging member 641 in the release position against an elastic force of the first engaging spring 642.

More specifically, a locked portion 641b of the engaging member 641 is locked by the first protrusion 65a of the temporary fastening member 65 attached to the support plate 60. Thus, the engaging member 641 is held in the release position.

On the other hand, by removing the temporary fastening member 65 from the support plate 60, the lock of the engaging member 641 by the first protrusion 65a is released. In this case, the engaging member 641 is held in the engaging position by the elastic force of the first engaging spring 642.

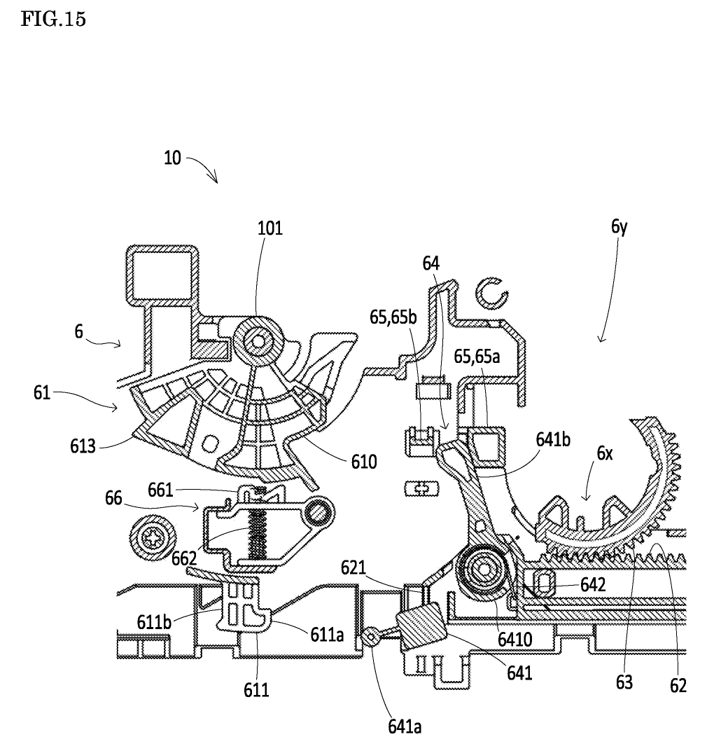

In a state in which the engaging member 641 is held in the release position, the pressed portion 621 of the rack gear 62 is located outside the movement path of the pivoting portion 611 of the linking member 61 that moves in conjunction with the opening and closing operation of the cover portion 100. Therefore, as shown in FIGS. 14 and 15, in a case in which the cover portion 100 is opened or closed with the engaging member 641 held in the release position, the pivoting portion 611 of the linking member 61 moves in conjunction with the opening and closing movement of the cover portion 100, but the rack gear 62 and the four pinion gears 63 do not move in conjunction with the opening and closing movement of the cover portion 100. Thus, the four shutter output portions 6x are held in the closed position, and the shutters 51 of the four toner containers 5 are held in the closed state.

When the temporary fastening member 65 is not attached, the auxiliary linking mechanism 64 links the rack gear 62 with the pivoting of the pivoting portion 611 of the linking member 61 that is linked to the closing operation of the cover portion 100.

In addition, when the temporary fastening member 65 is attached, the auxiliary linking mechanism 64 releases the linking of the rack gear 62 with the pivoting of the pivoting portion 611 of the linking member 61 that is linked to the closing operation of the cover portion 100.

In the main linking mechanism 6y, the auxiliary linking mechanism 64 and the temporary fastening member 65 are an example of a switching mechanism that switches the linking state of the main linking mechanism 6y. The switching mechanism is a mechanism that releases the linking of the shutter output portions 6x with the closing operation of the cover portion 100 in response to a predetermined release operation, and enables the linking in response to a predetermined enable operation.

In the main linking mechanism 6y, the release operation is an operation of attaching the temporary fastening member 65 to the support plate 60 of the attachment portion 6. In addition, the enable operation is an operation of removing the temporary fastening member 65 from the support plate 60.

In a case in which the temporary fastening member 65 is not attached, the main linking mechanism 6y, by linking the shutter output portions 6x with the opening and closing operation of the cover portion 100, causes the shutter output portions 6x to displace to the open position when the cover portion 100 is closed and causes the shutter output portions 6x to displace to the closed position when the cover portion 100 is opened.

On the other hand, in a case in which the temporary fastening member 65 is attached, the main linking mechanism 6y, by releasing the linking of the shutter output portions 6x with the opening and closing operation of the cover portion 100, holds the shutter output portions 6x in the closed position.

Therefore, in certain cases, such as when the image forming apparatus 10 is being transported, simply attaching the temporary fastening member 65 to the support plate 60 makes it possible to keep the cover portion 100 closed and prevent leaking of toner 90. Attaching the temporary fastening member 65 is a very simple task.

In addition, in a case in which the cover portion 100 is opened, the shutter 51 of the toner container 5 is closed without requiring any special operation, thereby preventing the toner 90 from leaking.

As described above, the main linking mechanism 6y includes the pivoting portion 611 that pivots in conjunction with the rotation of the rotation shaft 101 of the cover portion 100, the rack gear 62 that displaces in a linear direction in conjunction with the pivoting of the pivoting portion 611, the pinion gear 63 that causes the shutter output portions 6x to displace in conjunction with displacement of the rack gear 62, and the switching mechanism that switches between enabling and disabling the linking of the rack gear 62 with the closing operation of the cover portion 100. As a result, compared to the image forming apparatus according to the related art described above, the shutter 51 of the toner container 5 can be opened and closed in conjunction with the opening and closing operation of the cover portion 100 with a simpler configuration.

Note that in a case in which the image forming apparatus 10 is a monochrome image forming apparatus, the attachment portion 6 has a configuration in which only one toner container 5 is mounted. In this case, the attachment portion 6 includes one each of the shutter output portion 6x, the pinion gear 63, the rotation output portion 6z, and the holder.

### Application Example

Next, an application example of the main linking mechanism 6y that can be applied to the image forming apparatus 10 will be described.

The main linking mechanism according to the application example has a configuration in which the temporary fastening member 65 of the main linking mechanism 6y is replaced with a switch attached to the support plate 60. For example, the switch may be a slide switch. In this case, the switch is slidable between a position of the locking the locked portion 641b of the engaging member 641 and a position of being separated from the engaging member 641.

When the switch is switched ON, the switch is brought into a state in which the engaging member 641 is locked in the release position against the elastic force of the first engaging spring 642. In addition, when the switch is switched OFF, the switch is separated from the engaging member 641.

In the present application example, the auxiliary linking mechanism 64 and the switch are an example of the switching mechanism. In addition, the ON operation of the switch is an example of the release operation, and the OFF operation of the switch is an example of the enable operation.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an apparatus main body having an attachment portion therein to which one or more developing agent containers are attached, the developing agent containers having a storage portion configured to store a powder developing agent and a shutter input portion configured to receive an external force for opening and closing a shutter that closes a developing agent outlet, the apparatus main body having a main opening communicating with the attachment portion;
a cover portion supported by the apparatus main body and capable of opening and closing the main opening;
one or more shutter output portions provided in the apparatus main body corresponding to the developing agent container, each shutter output portion configured to engage with a shutter input portion and to be supported displaceably between an open position that opens the shutter via the shutter input portion and a closed position that closes the shutter via the shutter input portion; and
a main linking mechanism that is provided in the apparatus main body and that by linking the shutter output portion with the opening and closing operation of the cover portion is configured to cause the shutter output portion to displace to the open position when the cover portion is closed and cause the shutter output portion to displace to the closed position when the cover portion is opened; wherein
the main linking mechanism comprises:
a pivoting portion configured to pivot in conjunction with rotation of a rotation shaft of the cover portion that is rotatably supported;
a rack gear configured to displace in a linear direction in conjunction with the pivoting of the pivoting portion;
one or more pinion gears configured to mesh with the rack gear and cause the shutter output portion to displace in conjunction with displacement of the rack gear; and
a switching mechanism configured to release the linking of the shutter output portion with a closing operation of the cover portion in response to a predetermined release operation and enable the linking in response to a predetermined enable operation.

2. The image forming apparatus according to claim 1, wherein
the main linking mechanism causes the shutter output portion to displace to the closed position during an opening operation of the cover portion.

3. The image forming apparatus according to claim 1, wherein
when the main linking mechanism includes a plurality of the pinion gears, one rack gear engages with a plurality of the pinion gears.

4. The image forming apparatus according to claim 1, wherein
the switching mechanism comprises:
a temporary fastening member that is detachable from the attachment portion; and
an auxiliary linking mechanism configured to link the rack gear with the pivoting of the pivoting portion that is linked with the closing operation of the cover portion when the temporary fastening member is not attached, and to release the linking of the rack gear with the pivoting of the pivoting portion that is linked with the closing operation of the cover portion when the temporary fastening member is attached; wherein
the release operation is an operation of attaching the temporary fastening member to the attachment portion; and
the enable operation is an operation of removing the temporary fastening member from the attachment portion.

5. The image forming apparatus according to claim 4, wherein
the auxiliary linking mechanism includes an engaging member configured as a unit with the rack gear and an engaging elastic member configured to apply an elastic force to the engaging member;
the engaging member is supported to be pivotable between an engaging position of engaging with the pivoting portion in conjunction with a closing operation of the cover portion and a release position of no engagement with the pivoting portion;
the engaging elastic member holds the engaging member in the engaging position by elastic force;
the temporary fastening member, by being attached, locks the engaging member in the release position against the elastic force of the engaging elastic member; and
by the temporary fastening member being removed, engagement of the engaging member is released.

6. The image forming apparatus according to claim 1, comprising
a locking portion that locks the cover portion from rotating from an open state.
